(19) United States
(12) Patent Application Publication
(10) Pub. No.: US 2016/0178946 A1
(43) Pub. Date: Jun. 23, 2016

(54) TUNABLE REJECTION LIQUID CRYSTAL FILTER

(71) Applicant: THE SECRETARY OF STATE FOR DEFENCE, Salisbury, Wiltshire (GB)

(72) Inventor: RICHARD HOLLINS, SALISBURY (GB)

(73) Assignee: THE SECRETARY OF STATE FOR DEFENCE, SALISBURY, WILTSHIRE (GB)

(21) Appl. No.: 14/909,566

(22) PCT Filed: Aug. 6, 2013
(86) PCT No.: PCT/GB2013/000333

§ 371 Date: Feb. 2, 2016

(51) Int. Cl. G02F 1/133

(52) U.S. Cl. CPC G02F 1/13306

(57) ABSTRACT

Apparatus and method for tuning a liquid crystal filter to the wavelength of incoming electromagnetic radiation (such as visible light) by exploiting the AC error signal produced by the filter when a tuning error is present.

This invention concerns an apparatus and method for automatically tuning a liquid crystal filter accurately onto the wavelength of an incident laser, the intensity of which needs to be reduced whilst transmitting other less intense wavelengths. If the filter is tuned accurately to the laser wavelength, then the laser light can be removed, while light at other wavelengths is passed with little attenuation.

Several tuneable filter technologies are available, and liquid crystal (LC) filters are particularly important because of their compactness, low voltage requirement, wide aperture, and because high-quality cells are available.

The task of tuning the filter accurately to the laser has always presented difficulties. It becomes even more challenging as the rejection band is made narrower to minimise the degradation of vision.

The principal existing technique is based on measurement of the laser wavelength using some form of spectrometer. The appropriate driving voltage required by the filter is determined from the measured wavelength using a look-up table or similar. Unfortunately, the required rejection wavelength also depends upon the angle of incidence of the laser and the temperature. Additional sensors are therefore necessary to tune a filter to the required degree of precision. Moreover, simple spectrometers are sometimes confused under strong bright conditions.

Simple (DC) feedback loops form an alternative means of tuning the filter. The transmitted light can be monitored, and a feedback loop constructed to drive the voltage applied to the filter towards minimum transmission. Unfortunately the sensor is easily confused by the combination of laser light and background light.

The use of AC feedback loops to stabilise devices such as lasers is well known and described in, for example, “Atomic and Laser Spectroscopy”, A Corney, Oxford University Press 1977, pages 421-427.

International Patent Application WO 00/57217 discloses and illumination system that uses optical feedback to adjust optical filter characteristics. Light produced by the system is filtered by an electrically controllable optical filter, which is in communication with a light detector. The light is compared with at least one predetermined value and any difference forms the basis for a control signal which alters some characteristic of the filter. WO 00/57217 is concerned with maintaining a predetermined illumination output.

Japanese Patent application JP10239644 describes another filter system that employs a feedback loop. The filter's transmission is modulated by an imposed sinusoidal wave. A signal corresponding to the modulation in transmission is produced and the phase of this signal is compared with the imposed sinusoidal wave to derive a control signal for a feedback system. JP10239644 is concerned with maximising the transmission of a filter, for a given wavelength, in telecommunications applications.

The present invention provides a means of controlling a filter without imposing additional modulation. An electro-optical filter system is described in which the optimum rejection wavelength of the filter is automatically tuned to the wavelength of the incident radiation.

According to the present invention, apparatus for tuning a liquid crystal filter powered by an alternating driving voltage, to reject incident light comprises:

means for deriving an electrical signal from the variation in transmission of the filter associated with the alternating driving voltage wherein the sign of the electrical signal is dependent on whether the wavelength of the incident light is greater, or less than, the rejection wavelength of the filter and

means for deriving a control signal for the alternating driving voltage from the electrical signal.

Preferred features include that, the magnitude of the control signal is dependent on the magnitude of the electrical signal and that the alternating driving voltage takes the form of a square wave.

The apparatus may be arranged so that the alternating driving voltage is increased if the control signal is positive and decreased if the control signal is negative, or vice versa.

The apparatus may include a filter in which the birefringence increases with applied voltage or decreases with applied voltage.

According to a second aspect of the invention, a method of tuning a liquid crystal filter powered by an alternating driving voltage, to reject incident light, comprises the steps of

deriving an electrical signal from the variation in transmission of the filter associated with the alternating driving voltage wherein the sign of the electrical signal is dependent on whether the wavelength of the incident light is greater, or less than, the rejection wavelength of the filter and

increasing or decreasing the alternating driving voltage according to the sign of electrical signal so derived.

Embodiments of the invention will now be described, with reference to the following figures in which:

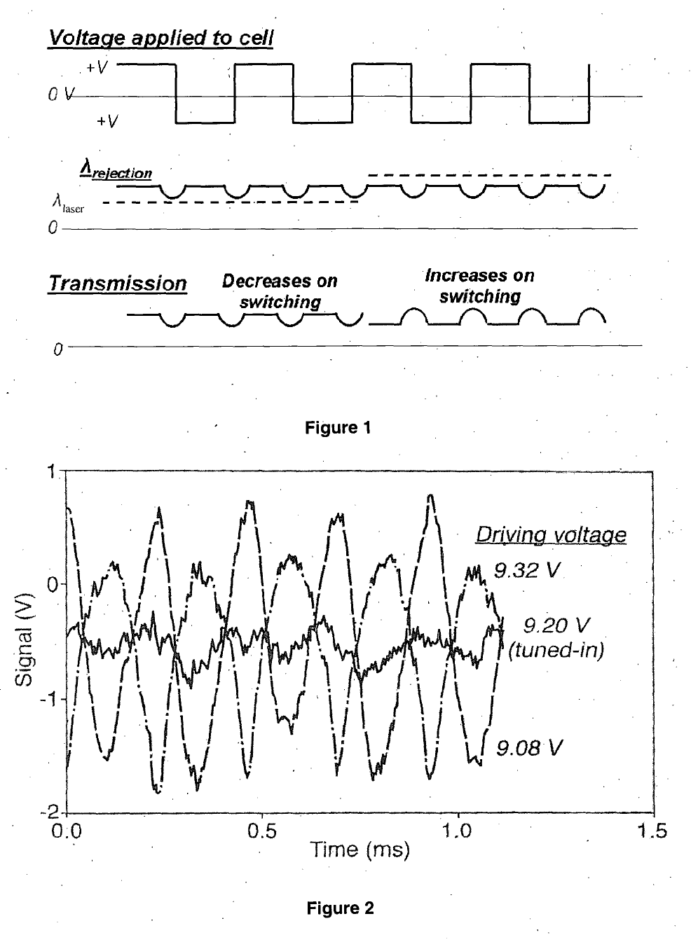

FIG. 1 illustrates the origin of an AC error signal that is produced by liquid crystal cells and exploited by the current invention;

FIG. 2 demonstrates the generation of AC error signals by liquid crystal cells, the effect exploited by the current invention and

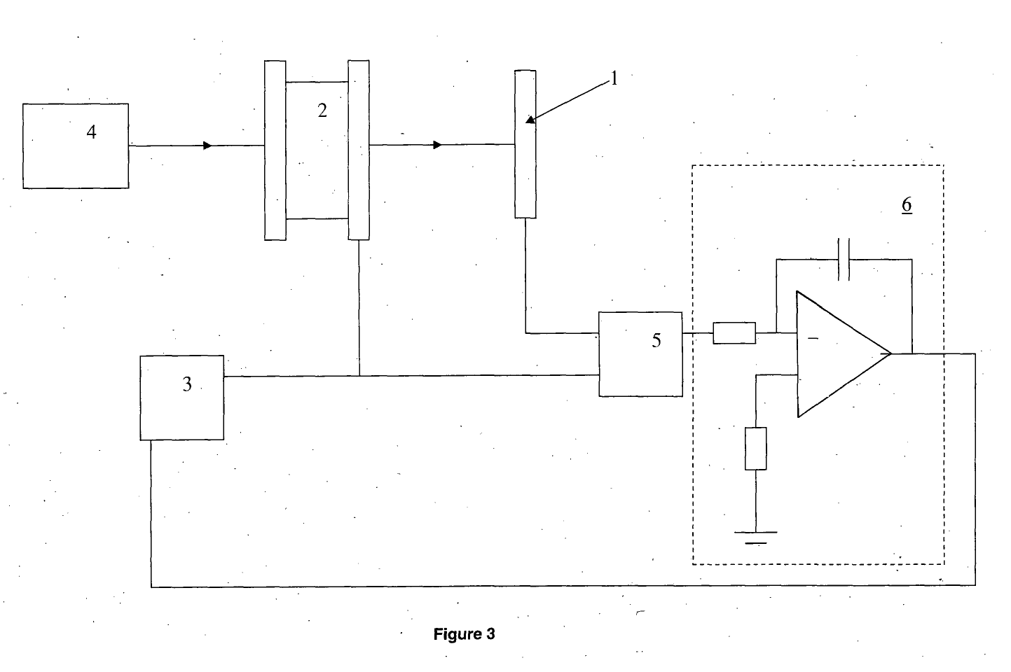

FIG. 3 illustrates an example embodiment of the invention.

During operation of LC filters, it is necessary to align the liquid crystal molecules in an electric field and to this end a voltage is applied which polarises the molecules. However, under the influence of a DC voltage, electrolysis of the liquid crystal material occurs leading to cell breakdown.

In order to overcome this problem of cell breakdown, the LC filters are driven by a symmetric square wave (alternating positive and negative values with equal amplitude). The frequency of the driving voltage is sufficiently high (˜1 kHz) for the molecules substantially to remain in position even though their polarisation reverses in sympathy with the sign of the driving voltage.

Because field reversal takes a finite time, the molecules do relax slightly (as the field strength passes through zero) and although this effect is not discernible during normal operation, there is an associated change in birefringence and hence transmission of the cell.

Throughout this description, the term “light” is used to refer to any electromagnetic radiation that may be filtered using a liquid crystal cell. It should not be construed as limited to that part of the electromagnetic spectrum that is visible to the human eye.

Referring to FIG. 1, application of a symmetric square wave voltage, oscillating between values of +V and −V, to a liquid crystal cell causes the rejection wavelength λ_{rejection} of the filter to dip each time the applied voltage switches between +V and −V (i.e. λ_{rejection} dips with twice the frequency of the applied voltage). When the wavelength of the laser, λₗₐₛₑᵣ, is below λ_{rejection} (the first half of the graph) each dip in the latter brings the two values closer together with a corresponding dip in the transmission of the filter. When λₗₐₛₑᵣ is above λ_{rejection} each dip in the latter brings the two values further apart with a corresponding rise in the transmission of the filter.

It is useful to the invention that the sign of the change in transmission of the filter depends on whether λₗₐₛₑᵣ, is below or above λ_{rejection} (i.e. depends on the sign of the tuning error). It will be appreciated that while FIG. 1 illustrates a situation where λ_{rejection} remains constant and λₗₐₛₑᵣ is first below then above λ_{rejection}, the same observation may be made λₗₐₛₑᵣ when is constant and the filter is tuned so that λ_{rejection} is first above and then below λₗₐₛₑᵣ.

FIG. 1 and the foregoing description are concerned with devices in which the birefringence increases as the applied voltage increases but the invention should not be seen as limited thereto. In particular it will be understood that in many devices, the birefringence decreases as the applied voltage increases. The current invention is equally, applicable to such devices.

Referring to FIG. 2, a filter containing a nematic liquid crystal cell was mounted between parallel polarisers, and driven by a symmetric square wave signal of frequency 2 kHz and adjustable amplitude. The filter was used to reject a low-power continuous laser beam of wavelength 532 nm. The transmitted light was sampled using a photodiode, and the AC error signal, that is the AC component of the signal associated with the variation in transmission of the filter caused by the square wave driving voltage, was filtered and amplified by an AC amplifier before being recorded using an oscilloscope. As with variation in transmission of the filter, the sign of the AC error signal depends on the sign of the tuning error of the filter. Three different AC error signals are illustrated, having been recorded with the applied voltage adjusted to tune the filter to wavelengths just above, below and equal to the laser wavelength. The AC error signals become very clear when the filter is detuned to any significant extent, and the sign of the signal changes when the filter is tuned through the laser wavelength. The wavelength offsets required to produce the strong signals shown in FIG. 2 are small: the rejection of the laser decreased only slightly, from OD 2.0 to OD 1.9. The technique therefore exhibits the sensitivity to lock a filter tightly and accurately to the laser wavelength.

Referring to FIG. 3, a particular embodiment of the invention employs a light detector 1 such as a photodiode to produce an electrical signal which is a measure of the light transmitted through the liquid crystal cell 2. Signal generator 3 provides the square wave driving voltage for cell 2 and, as described previously, this causes a variation in the transmission of the cell 2 (and hence gives rise to an AC output from detector 1) whose sign depends on the tuning error of cell 2 with respect to laser 4.

Phase sensitive detector 5 derives a DC signal from the output of detector 1 whose sign is dependent on the tuning error and this signal is integrated by integrator 6 to produce a control voltage that is used to adjust the amplitude of the output from generator 3. The sign and magnitude of the control voltage produced by integrator 6 are dependent on the sign and magnitude of the AC error signal

Generator 3 also produces the reference signal for phase sensitive detector 5.

It will be appreciated that FIG. 3 illustrates in general terms one example of how the AC error signal derivable from the transmission of a LC filter might be used to produce a control signal that is used to tune the filter to the wavelength of the incoming laser. Other methods of achieving this result will be apparent to persons skilled in the art.

1. Apparatus for tuning a liquid crystal filter powered by an alternating driving voltage, to reject incident light comprising:
means for deriving an electrical signal from the variation in transmission of the filter associated with the alternating driving voltage wherein the sign of the electrical signal is dependent on whether the wavelength of the incident light is greater, or less than, the rejection wavelength of the filter and
means for deriving a control signal for the alternating driving voltage from the electrical signal.

2. The apparatus of claim 1, wherein the magnitude of the control signal is dependent on the magnitude of the electrical signal.

3. The apparatus of claim 1, wherein the alternating driving voltage takes the form of a square wave.

4. The apparatus of claim 1, arranged so that the alternating driving voltage is increased if the control signal is positive and decreased if the control signal is negative.

5. The apparatus of claim 1, arranged so that the alternating driving voltage is decreased if the control signal is positive and increased if the control signal is negative.

6. The apparatus of claim 1 in which the birefringence of the filter increases with applied voltage.

7. The apparatus of claim 1 in which the birefringence of the filter decreases with applied voltage.

8. Use of apparatus according to claim 1 for the protection against laser damage.

9. A method of tuning a liquid crystal filter powered by an alternating driving voltage, to reject incident light, comprising the steps of:
deriving an electrical signal from the variation in transmission of the filter associated with the alternating driving voltage wherein the sign of the electrical signal is dependent on whether the wavelength of the incident light is greater, or less than, the rejection wavelength of the filter and
increasing or decreasing the alternating driving voltage according to the sign of electrical signal so derived.
